(19) United States
(12) Patent Application Publication
(10) Pub. No.: US 2015/0202977 A1
(43) Pub. Date: Jul. 23, 2015

(54) VEHICLE-CHARGED SUPPLEMENTAL POWER SYSTEM

(71) Applicant: Michael Rutledge McCall, Santa Monica, CA (US)

(72) Inventor: Michael Rutledge McCall, Santa Monica, CA (US)

(21) Appl. No.: 14/161,529

(22) Filed: Jan. 22, 2014

(51) Int. Cl. B60L 11/18

(52) U.S. Cl. CPC B60L 11/1851

(57) ABSTRACT

Apparatuses, systems and methods are disclosed for vehicle-charged supplemental power and its concomitant energy collection, storage, and distribution. In one implementation, an apparatus is provided including a battery configured to be portable and a vehicle component including an electrical vehicle connection system to connect the battery to the alternator of a vehicle, and a control unit coupled to the electrical vehicle connection system and configured to isolate the battery from supplying charge to a vehicle system when the battery is connected to the electrical vehicle connection system, and further configured to connect or disconnect the battery to the alternator of the vehicle. In another aspect, an apparatus is provided including one or more batteries connected to a vehicle engine and configured to be charged by the engine, wherein the batteries are configured to be selectively disconnected from the vehicle engine and selectively connected to an electric wiring system.

### TECHNICAL FIELD

Aspects and implementations of the present disclosure relate to a vehicle-charged supplemental power system.

### BACKGROUND

Many vehicles such as automobiles utilize combustion engines in order to generate power and enable their movement.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, an apparatus is provided including a battery configured to be portable and a vehicle component including an electrical vehicle connection system to connect the battery to the alternator of a vehicle, and a control unit coupled to the electrical vehicle connection system, the control unit configured to isolate the battery from supplying charge to a vehicle system when the battery is connected to the electrical vehicle connection system, and further configured to connect or disconnect the battery to the alternator of the vehicle.

In another aspect, an apparatus is provided including one or more batteries connected to a vehicle engine and configured to be charged by the vehicle engine, wherein the one or more batteries are configured to be selectively disconnected from the vehicle engine and selectively connected to an electric wiring system.

In another aspect, a processor is configured to monitor a first energy consumption load corresponding to a first circuit and a second energy consumption load corresponding to a second circuit, process the first energy consumption load and the second energy consumption load to identify an energy consumption load capable of fulfillment by a supplemental power source, and adjusting at least one of the first circuit or the second circuit to receive power from the supplemental power source.

In another aspect, an apparatus is provided including an energy diversion apparatus to identify and monitor energy consumption needs and selectively divert energy from the battery or batteries to specific devices, apparatus or locations as needed and directed.

In another aspect, an apparatus is proved including an energy distribution device to direct energy from a portable vehicle component directly to an energy diversion apparatus.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative arrangement of the technologies described herein, in accordance with one implementation of the present disclosure.

FIG. 2 depicts an illustrative arrangement of the technologies described herein, in accordance with one implementation of the present disclosure.

FIG. 3 depicts an illustrative arrangement of the technologies described herein, in accordance with one implementation of the present disclosure.

FIG. 4 depicts a flow diagram of aspects of a method for providing power from a supplemental power source, in accordance with one implementation of the present disclosure.

FIG. 5 depicts a block diagram of an illustrative computer system operating in accordance with aspects and implementations of the present disclosure.

FIG. 6 depicts an illustrative arrangement of the technologies described herein, in accordance with one implementation of the present disclosure.

FIG. 7 depicts an illustrative arrangement of the technologies described herein, in accordance with one implementation of the present disclosure.

### DESCRIPTION OF EMBODIMENTS

Aspects and implementations of the present disclosure are directed to a vehicle-charged supplemental power system. It can be appreciated that a huge volume of motor vehicles are being driven or idling on our streets and highways. While cars and trucks get us to and from where we need to go, they also constantly generate energy, much of which is not fully utilized. Accordingly, the various apparatuses and systems described herein enable improved utilization and conservation of the electric generating power that today's vehicles already possess. These technologies can enable users to power a house or office building, providing considerable cost savings and environmental benefits.

The technologies described herein utilize vehicle (e.g., automobile) drive-time to charge a rack of batteries in the trunk of the vehicle. These batteries can be designed to be portable so they can be easily transferred from the vehicle to a house or office building, such as in order to supplement the municipal power grid and/or solar panel system. In doing so, the need for power from the electric grid can be significantly reduced. Additionally, the technologies described herein can provided users with electricity in circumstances where it may not otherwise be available (e.g., on a cloudy days when solar power is unavailable).

By merely driving a vehicle to and from work or other destinations each day, a household that has at least one car equipped with the described system can supply enough additional electricity to provide up to 20% (or more) of the home's electricity needs. When combining the described energy creation system with a home's solar power system, a substantial portion of a house or small building can operate for large periods of time completely off of the municipal power grid, and may be capable of bearing the entire electricity needs for off-peak or lowest-use hours.

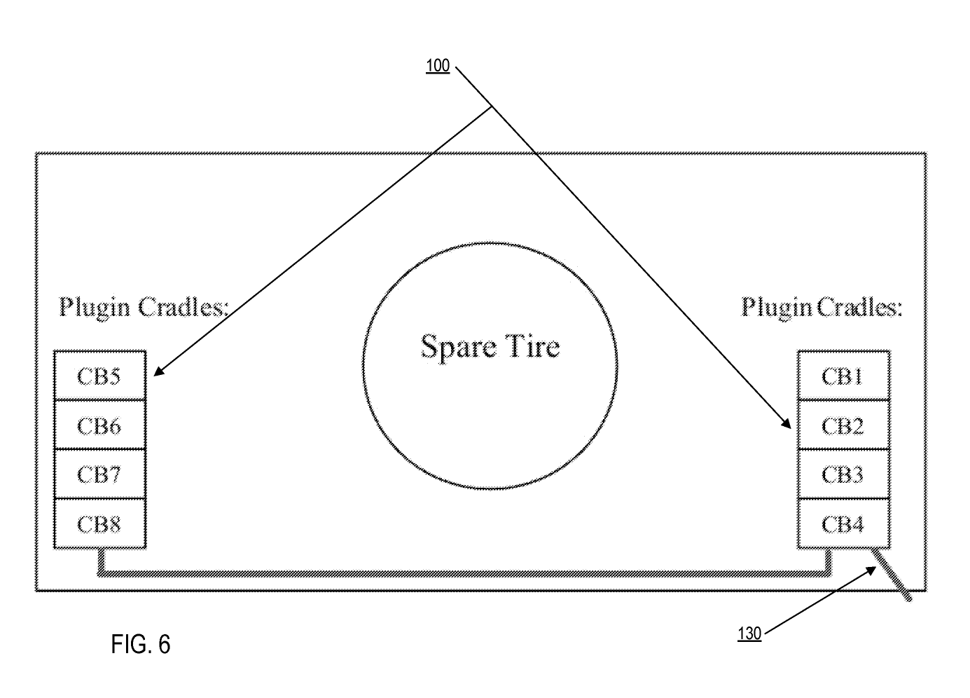

As described in detail herein, a vehicle-charged supplemental power system can include a battery (e.g., a NiCad or lithium ion portable battery) or series of batteries and a vehicle component (that can be configured to allow the battery to be stored in a storage area of the vehicle, such as a trunk, or any other area within the vehicle, such as is depicted in FIG. 6 and described herein) which can include an electrical vehicle connection system to connect the battery to the alternator of a vehicle as well as a control unit/onboard computing device. Such a control unit/computing device can be connected and/or coupled to the electrical vehicle connection system and can be configured to isolate the battery from supplying charge to a vehicle system when the battery is connected to the electrical vehicle connection system. Additionally, the control unit can be configured to connect and/or disconnect the battery to the alternator of the vehicle. In certain implementations, the control unit/computing device can be configured to oversee, manage, and/or control the electric charging of the battery (or batteries) when such battery/batteries are inserted into a battery, such as is described herein. Additionally, in certain implementations such a control unit/computing device can generate and/or provide various notifications (e.g., to a user via a display interface) such as notifications that reflect the level of charge the battery or series of batteries contains (e.g., by percentage and/or time), if and when the battery is fully charged, and/or how much time remains until the battery or series of batteries is fully charged. In certain implementations, the control unit/computing device can be configured to turn on or off various charging function(s) of the battery or series of batteries as needed, such as in order to stop charging when the battery or series of batteries is fully charged and/or to start charging when the battery or series of batteries is in need of charging. Additionally, in certain implementations such a control unit/computing device can be configured to isolate the battery or series of batteries from supplying charge to an automobile's system when the battery or series of batteries is connected to the automobile motor's alternator and/or electrical charging system, connect or disconnect the battery or series of batteries to the alternator of the automobile, and/or monitors and controls the load of the battery or series of batteries system according to the operating cycle of the electric energy generating source in conjunction with the battery or series of batteries' electric energy level, such as is described herein. Moreover, in certain implementations the vehicle component can also include a mount rack connected to the electrical vehicle connection system. Such a mount rack can be configured to allow the battery to be connected to the electrical vehicle connection system (e.g., to connect the battery or series of batteries to an alternator or to any other source that generates electricity, such as can be located in an vehicle/automobile) or removed from the mount rack by a force along a single axis.

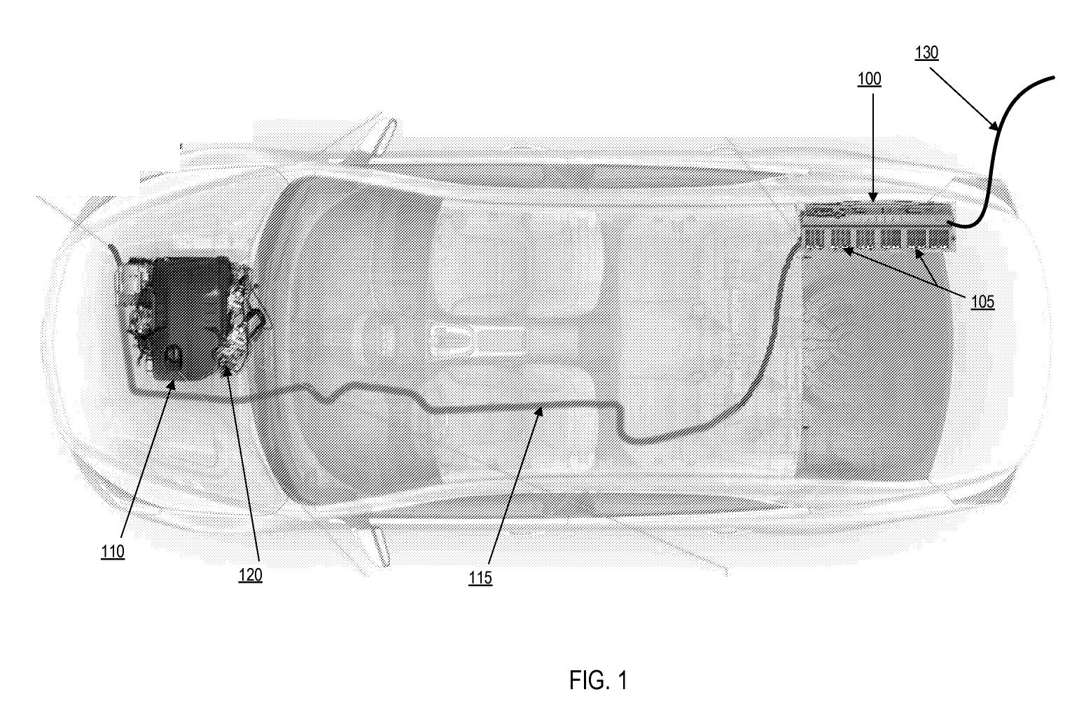

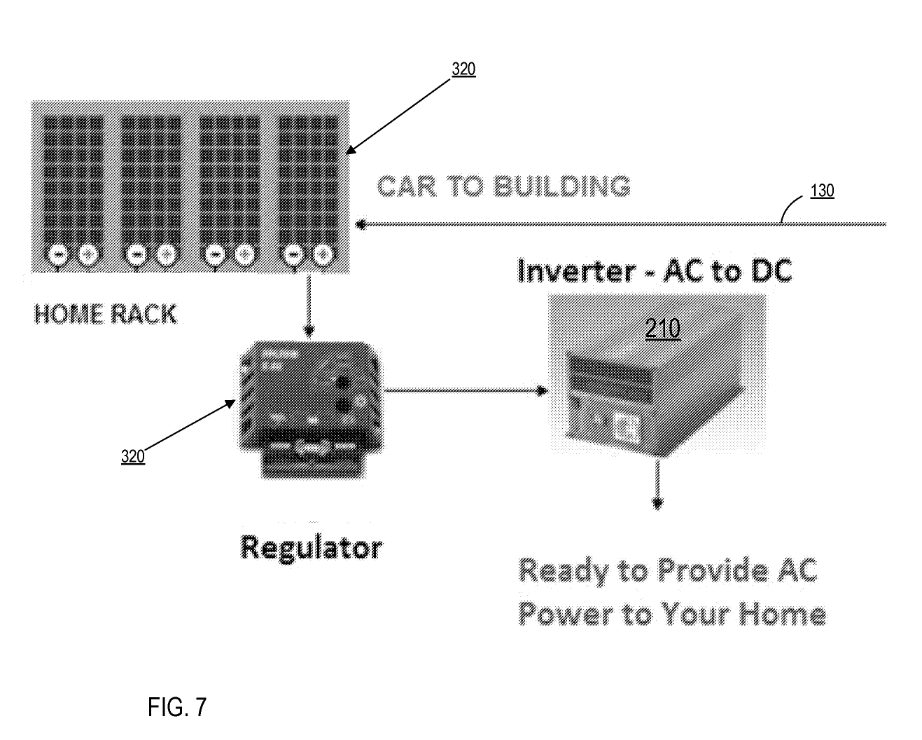

Additionally, in certain implementations the vehicle-charged supplemental power system can include a vehicle adaptor component, which can connect the battery to a source external to the vehicle. Moreover, the vehicle adaptor component can be configured to allow the battery to supply charge outside of the vehicle while the battery remains in the vehicle. In certain implementations, a mount rack can be located in a house or building into which the battery or series of batteries may be inserted to operate in conjunction with the electrical/power system of a house or building. In doing so, electric power can be provided from the battery to the house or building. Additionally, in certain implementations a power cord system can be connected (e.g., using cord 130 as depicted in FIG. 1, FIG. 6, and FIG. 7) from the battery or series of batteries' rack in the vehicle/automobile directly to a house or building (thereby utilizing the battery or series of batteries in the vehicle/automobile rack as an electric power provider). Moreover, by turning on the automobile's motor, the motor may also continuously charge the battery or series of batteries, thereby supplying continuous power to the house or building. In doing so, the vehicle/automobile adaptor component can connect the battery or series of batteries to a source external to the vehicle/automobile such that the vehicle/automobile adaptor component is configured to allow the battery or series of batteries to supply charge outside of the vehicle/automobile while the battery or series of batteries remains in the vehicle/automobile (e.g., to charge).

In certain implementations, the referenced vehicle component can include an indicator which can be configured to indicate whether the battery is charging, not charging, the charge level of the battery, etc.

In certain implementations, the referenced vehicle component can include a converter unit which can convert direct current to alternating current when connected to the battery (e.g., when the converter unit connects to an alternating current electrical system such as the electrical system of a building).

Moreover, in certain implementations the vehicle-charged supplemental power system can include one or more batteries connected to a vehicle engine (e.g., via wiring) that are configured to be charged by the vehicle engine. As described in detail herein, such batteries can be configured for placement within a storage area of a vehicle an can be further configured to be selectively disconnected from the vehicle engine and selectively connected to an electric wiring system. The vehicle-charged supplemental power system can also include wiring configured to connect the one or more batteries and the electric wiring system. Additionally, a controller can be included which can be configured to manage charging of the one or more batteries.

FIG. 1 depicts an illustrative arrangement of the technologies described herein, in accordance with one implementation of the present disclosure. As described herein and as shown in FIG. 1, a vehicle (e.g., a car, bus, etc.) can be configured with a battery rack 100 which can include one or more (e.g., six) batteries 105. Such batteries can be rechargeable batteries, including but not limited to NiCad or lithium ion batteries. As shown in FIG. 1, battery rack 100 can be designed or configured for placement in various storage spaces within the vehicle, such as within the vehicle's trunk. In doing so, the battery rack can be easily installed within existing vehicles, unobtrusive to the user while driving, and easily inserted and removed.

As described herein, battery rack 100 can be connected to the engine 110 of the vehicle via wiring 115, such as in a manner known to those of ordinary skill in the art. In doing so, wiring 115 can provide electric power generated by engine 110 to battery rack 100, thereby charging the various batteries 105. For example, while the vehicle is driving, idling, etc., the battery rack can be charged from electricity generated by the engine.

A controller 120 can be configured to enable intelligent charging of battery rack 100 by engine 110. For example, controller 120 can monitor the electrical requirements of the vehicle itself (e.g., of the vehicle's electrical systems, the vehicle engine's battery, etc.). Based on such monitoring, the controller 120 can selectively prevent charging of battery rack 100, such as in scenarios where the electrical systems of the vehicle itself, the battery of the engine itself, etc. require additional electricity from the engine 110. Upon determining that such systems no longer need additional electricity, controller 120 can allow battery rack 100 to resume charging from engine 110. Moreover, in certain implementations controller 120 can be configured to monitor the charge level of the battery rack 100 (and/or of individual batteries 105) and can provide an indicator to a driver/user (e.g., a dashboard light or notification) indicating that the battery rack is usable, partially charged, fully charged, etc.

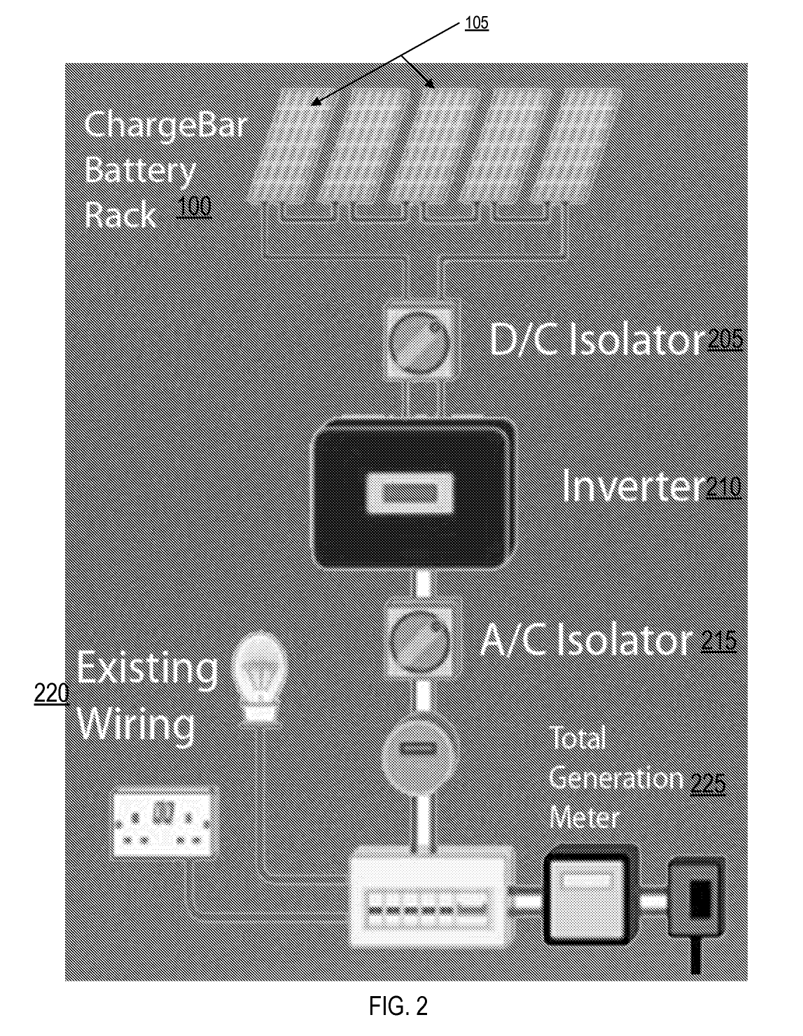

FIGS. 2, 3, 6 and 7 depict further illustrative arrangements of the technologies described herein, in accordance with one implementation of the present disclosure. As described herein and as shown in FIG. 2, battery rack 100 can be removed from vehicle and/or can be connected to an electric wiring system such as a home or office electric grid/panel. In doing so, the battery rack 100 can be utilized as a power source by the home/office power grid in lieu of other sources of electricity. In utilizing power from battery rack 100 instead of other power sources, consumers can realize considerable cost savings.

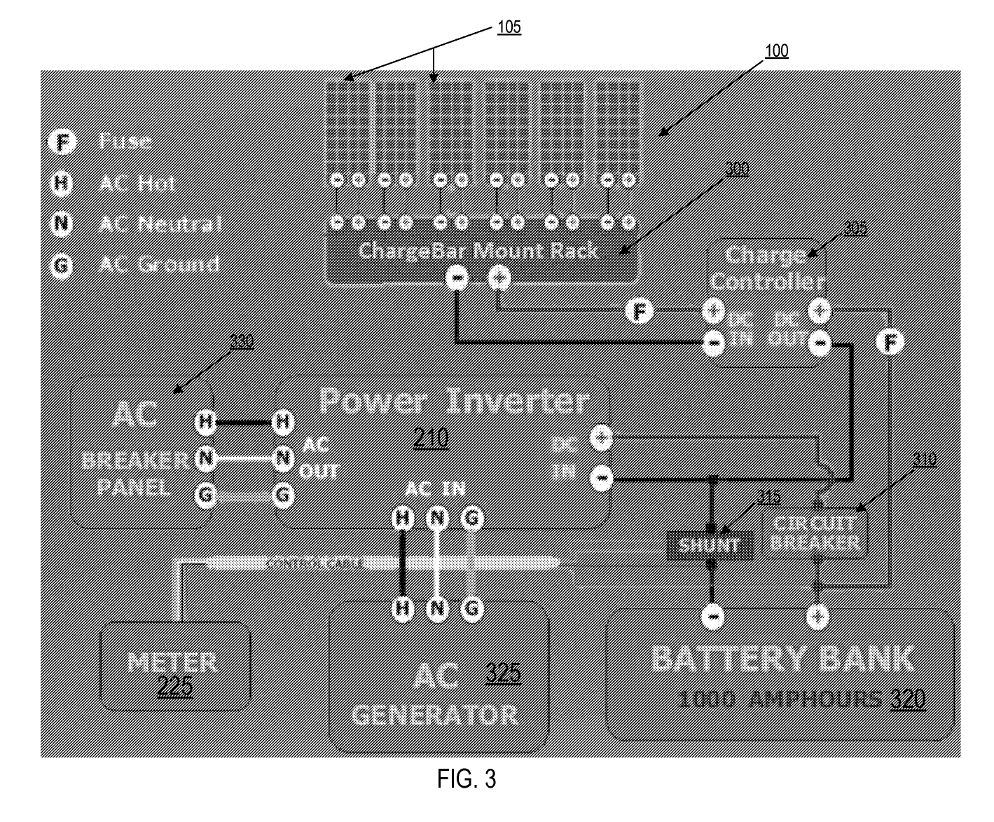

In one implementation, a user wishing to utilize power from battery rack 100 can remove and/or disconnect battery rack 100 from the vehicle to which it is connected. Battery rack 100 can then be connected to a mount rack 300 (as shown in FIG. 3) which can be a dock having electrical connectors arranged for engagement with corresponding connectors of battery rack 100. In another implementation, battery rack 100 can be configured with wiring (e.g., an electric cable) that enables the battery rack to remain within the vehicle while being connected to a home/office power grid.

Power from battery rack 100 can then be utilized in any number of ways. For example, as depicted in FIGS. 2, 3 and 7, DC power originating from the battery rack 100 can be converted into AC power via power inverter 210, such as in a manner known to those of ordinary skill in the art. In certain implementations, battery bank 320 (e.g., a larger battery located at the home/office) can be charged from the power contained in battery rack 100. In other implementations, existing wiring 220 can utilize power from the battery rack 100, on an ongoing and/or as-needed/on demand basis. A meter 225 can be implemented in order to track and monitor the usage of electricity (both electricity from the battery rack 100 as well as from other sources), such as in a manner known to those of ordinary skill in the art.

Various additional components and/or elements can also be incorporated, such as in a manner known to those of ordinary skill in the art, including but not limited to: D/C isolator 205, A/C isolator 215, charge controller 305, circuit breaker 310, shunt 315, AC generator 325, and/or AC breaker panel 330.

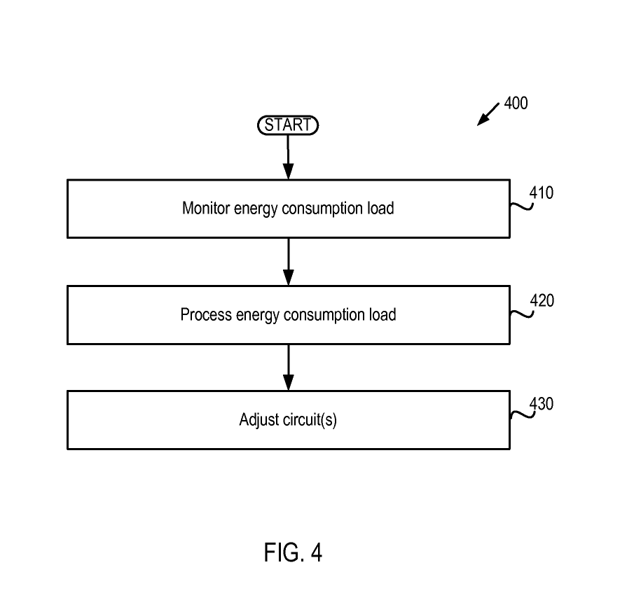

FIG. 4 depicts a flow diagram of aspects of a method 400 for providing power from a supplemental power source. The method is performed by processing logic that may comprise hardware (circuitry, dedicated logic, etc.), software (such as is run on a general purpose computer system or a dedicated machine), or a combination of both. In various implementations, one or more blocks of FIG. 4 may be performed by machines such as those described herein and depicted in FIGS. 1-3 (e.g., meter 225).

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 410, a first energy consumption load can be monitored. Such a load can correspond to a first circuit (e.g., a first appliance, room, floor, unit, etc.). Additionally, a second energy consumption load can be monitored. Such a load can correspond to a second circuit (e.g., a second appliance, room, floor, unit, etc.).

At block 420, the first energy consumption load and the second energy consumption load can be processed. In doing so, an energy consumption load capable of fulfillment by a supplemental power source (e.g., battery rack 100, as described herein) can be identified.

At block 430, the first circuit and/or the second circuit can be adjusted. For example, one or more aspects, settings, and or configurations of such circuit(s) can be adjusted in order to receive power from the supplemental power source (e.g., battery rack 100). In doing so, power can be provided to first circuit and/or the second circuit from the supplemental power source in lieu of receiving power from a primary power source.

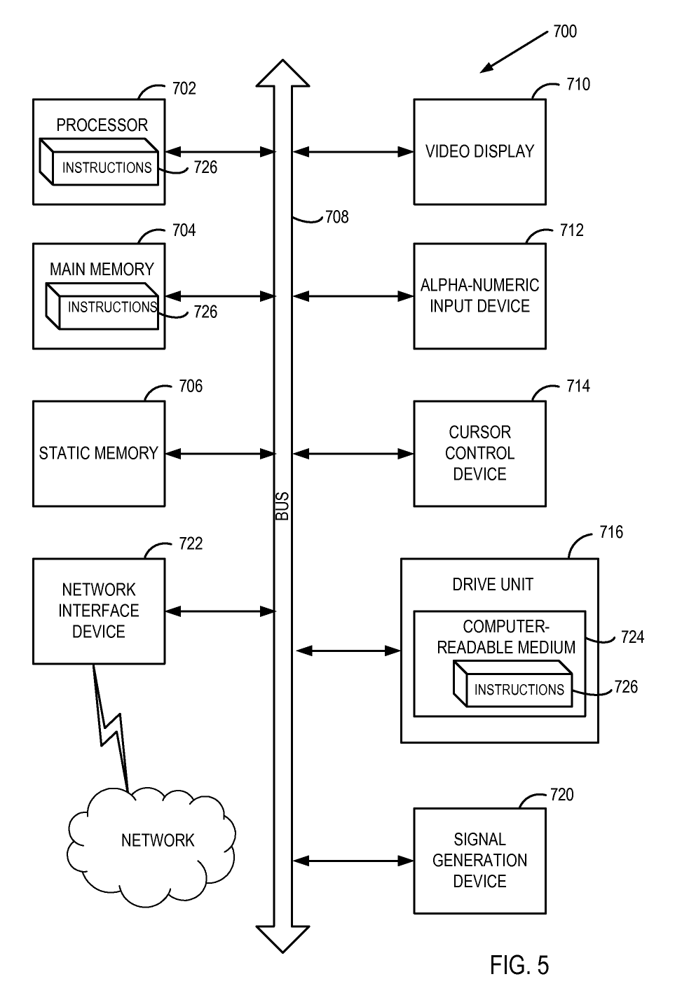

FIG. 5 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing system (processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 716, which communicate with each other via a bus 708.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 may also be one or more special-purpose processing devices such as an application specific integrated circuit (ASIC), a field programmable gate array (FPGA), a digital signal processor (DSP), network processor, or the like. The processor 702 is configured to execute instructions 726 for performing the operations and steps discussed herein.

The computer system 700 may further include a network interface device 722. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker).

The data storage device 716 may include a computer-readable medium 724 on which is stored one or more sets of instructions 726 (e.g., instructions executed by collaboration manager 225, etc.) embodying any one or more of the methodologies or functions described herein. Instructions 726 may also reside, completely or at least partially, within the main memory 704 and/or within the processor 702 during execution thereof by the computer system 700, the main memory 704 and the processor 702 also constituting computer-readable media. Instructions 726 may further be transmitted or received over a network via the network interface device 722.

While the computer-readable storage medium 724 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “providing,” “precluding,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

What is claimed is:

1. An apparatus comprising:
a battery, wherein the battery is configured to be portable; and
a vehicle component comprising:
an electrical vehicle connection system to connect the battery to the alternator of a vehicle; and
a control unit coupled to the electrical vehicle connection system, the control unit configured to isolate the battery from supplying charge to a vehicle system when the battery is connected to the electrical vehicle connection system, and further configured to connect or disconnect the battery to the alternator of the vehicle.

2. The apparatus of claim 1, further comprising a vehicle adaptor component, wherein the vehicle adaptor component connects the battery to a source external to the vehicle, and wherein the vehicle adaptor component is configured to allow the battery to supply charge outside of the vehicle while the battery remains in the vehicle.

3. The apparatus of claim 1, wherein the vehicle component is configured to allow the battery to be stored in a storage area of the vehicle.

4. The apparatus of claim 3, wherein the storage area of the vehicle is the trunk of vehicle.

5. The apparatus of claim 1, wherein the vehicle component further comprises a mount rack, the mount rack connected to the electrical vehicle connection system, the mount rack configured to allow the battery to be connected to the electrical vehicle connection system or removed from the mount rack by a force along a single axis.

6. The apparatus of claim 1, wherein the vehicle component further comprises an indicator, the indicator to indicate whether the battery is charging or not charging.

7. The apparatus of claim 6, wherein the indicator further indicates the charge level of the battery.

8. The apparatus of claim 1, wherein the battery comprise at least one of a NiCad battery or a lithium ion battery.

9. The apparatus of claim 1, further comprising a converter unit, the converter unit to convert direct current to alternating current when connected to the battery.

10. The apparatus of claim 9, wherein the converter unit connects to an alternating current electrical system.

11. The apparatus of claim 10, wherein the alternating current electrical system is the electrical system of a building.

12. An apparatus comprising:
one or more batteries connected to a vehicle engine and configured to be charged by the vehicle engine;
wherein the one or more batteries are configured to be selectively disconnected from the vehicle engine and selectively connected to an electric wiring system.

13. The apparatus of claim 12, wherein the one or more batteries are configured for placement within a storage area of a vehicle.

14. The apparatus of claim 12, wherein the one or more batteries are connected to the vehicle engine via wiring.

15. The apparatus of claim 12, further comprising wiring configured to connect the one or more batteries and the electric wiring system.

16. The apparatus of claim 12, further comprising a controller configured to manage charging of the one or more batteries.

17. A method comprising:
monitoring a first energy consumption load corresponding to a first circuit and a second energy consumption load corresponding to a second circuit;
processing, with a processing device, the first energy consumption load and the second energy consumption load to identify an energy consumption load capable of fulfillment by a supplemental power source; and
adjusting at least one of the first circuit or the second circuit to receive power from the supplemental power source.

18. The method of claim 17, wherein the supplemental power source comprises a battery configured for charging by a vehicle.

19. The method of claim 17, wherein adjusting least one of the first circuit or the second circuit comprises providing power to the at least one of the first circuit or the second circuit from the supplemental power source in lieu of receiving power from a primary power source.
